(19) United States
(12) Patent Application Publication
(10) Pub. No.: US 2023/0113942 A1
(43) Pub. Date: Apr. 13, 2023

(54) SIDELINK POWER CONTROL FOR MULTIPLEXED TRANSMISSIONS

(71) Applicant: QUALCOMM Incorporated, San Diego, CA (US)

(72) Inventors: Hua Wang, Basking Ridge, NJ (US); Sony Akkarakaran, Poway, CA (US); Gabi Sarkis, San Diego, CA (US); Tao Luo, San Diego, CA (US); Junyi Li, Fairless Hills, PA (US)

(21) Appl. No.: 17/496,731

(22) Filed: Oct. 7, 2021

(51) Int. Cl. H04W 52/24; H04W 24/08; H04L 5/00

(52) U.S. Cl. CPC H04W 52/242; H04W 24/08; H04L 5/0048

(57) ABSTRACT

Methods, systems, and devices for wireless communications are described. A first user equipment (UE) may determine a first sidelink pathloss based at least in part on a first sidelink reference signal from a second UE. The first UE may also determine a second sidelink pathloss based at least in part on a second sidelink reference signal received from a third UE. The first UE may transmit, during a transmission time interval, a first sidelink transmission to the second UE using a first transmit power that is based at least in part on the first sidelink pathloss and a second sidelink transmission to the third UE using a second transmit power that is based at least in part on the second sidelink pathloss. The first sidelink transmission may be transmitted at a first frequency and the second sidelink transmission may be transmitted at a second frequency.

### FIELD OF TECHNOLOGY

The following relates to wireless communications, including sidelink power control for multiplexed transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support communications between UEs, which may be referred to as sidelink communications. In sidelink communication scenarios, a first UE (transmitting UE) may transmit a message to a second UE (receiving UE), and the second UE may transmit feedback corresponding to the transmission. The feedback may indicate whether the second UE was able to successfully decode the transmission. In some cases, the second UE may utilize power control techniques to determine a transmission power for transmitting the feedback.

### SUMMARY

The described techniques relate to improved methods, systems, devices, and apparatuses that support sidelink power control for multiplexed transmissions. Generally, the described techniques provide for a user equipment (UE) using different transmit powers for sidelink communications that are frequency domain multiplexed. A first UE may determine a first sidelink pathloss based at least in part on a first sidelink reference signal from a second UE. The first UE may also determine a second sidelink pathloss based at least in part on a second sidelink reference signal received from a third UE. The first UE may transmit, during a transmission time interval, a first sidelink transmission to the second UE using a first transmit power that is based at least in part on the first sidelink pathloss and a second sidelink transmission to the third UE using a second transmit power that is based at least in part on the second sidelink pathloss. The first sidelink transmission may be transmitted at a first frequency and the second sidelink transmission may be transmitted at a second frequency.

A method for wireless communications at a first user equipment (UE) is described. The method may include determining a first sidelink pathloss based on a first sidelink reference signal received from a second UE, determining a second sidelink pathloss based on a second sidelink reference signal received from a third UE, and transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

An apparatus for wireless communications is described. The apparatus may include a processor of a user equipment (UE), a transceiver coupled with the processor, and memory coupled with the processor. The processor and memory may be configured to cause the apparatus to determine a first sidelink pathloss based on a first sidelink reference signal received from a second UE, determine a second sidelink pathloss based on a second sidelink reference signal received from a third UE, and transmit, via the transceiver, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

Another apparatus for wireless communications at a first UE is described. The apparatus may include means for determining a first sidelink pathloss based on a first sidelink reference signal received from a second UE, means for determining a second sidelink pathloss based on a second sidelink reference signal received from a third UE, and means for transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

A non-transitory computer-readable medium storing code for wireless communications at a first UE is described. The code may include instructions executable by a processor to determine a first sidelink pathloss based on a first sidelink reference signal received from a second UE, determine a second sidelink pathloss based on a second sidelink reference signal received from a third UE, and transmit, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

Some examples of the method, apparatuses, and non-transitory computer-readable medium described herein may further include operations, features, means, or instructions for transmitting, to a base station, an indication that the first UE may be capable of transmitting a quantity of frequency domain multiplexed transmissions with different transmit powers, where the first UE transmits the first sidelink transmission using the first transmit power and the second sidelink transmission using the second transmit power based on transmitting the indication.

In some examples of the method, apparatuses, and non-transitory computer-readable medium described herein, the first UE may be capable of transmitting frequency domain multiplexed transmissions with different transmit powers based on the first UE being configured with two or more radio frequency transmission chains.

In some examples of the method, apparatuses, and non-transitory computer-readable medium described herein, the first UE may be capable of transmitting frequency domain multiplexed transmissions with different transmit powers using a single radio frequency transmission chain.

Some examples of the method, apparatuses, and non-transitory computer-readable medium described herein may further include operations, features, means, or instructions for receiving a control message that indicates a mapping of the second UE to a first sidelink feedback channel group and of the third UE to a second sidelink feedback channel group, where the first UE transmits a first sidelink feedback channel message as the first sidelink transmission using the first transmit power and a second sidelink feedback channel message as the second sidelink transmission using the second transmit power based on receiving the control message that indicates the mapping.

In some examples of the method, apparatuses, and non-transitory computer-readable medium described herein, receiving the control message may include operations, features, means, or instructions for receiving, from a base station, a radio resource control message, a medium access control layer control element message, or a downlink control information message that indicates the mapping.

In some examples of the method, apparatuses, and non-transitory computer-readable medium described herein, receiving the control message may include operations, features, means, or instructions for receiving, from the second UE, the third UE, or both, a sidelink radio resource control message, a sidelink medium access control layer control element message, or a sidelink control information message that indicates the mapping.

In some examples of the method, apparatuses, and non-transitory computer-readable medium described herein, receiving the control message may include operations, features, means, or instructions for receiving an indication that the first sidelink reference signal may be to be used for determining the first sidelink pathloss and the second sidelink reference signal may be to be used for determining the second sidelink pathloss.

Some examples of the method, apparatuses, and non-transitory computer-readable medium described herein may further include operations, features, means, or instructions for transmitting to a fourth UE during the transmission time interval, a third sidelink feedback channel message using the first transmit power that may be based on the first sidelink pathloss in accordance with the fourth UE being grouped with the second UE for sidelink feedback channel transmission.

In some examples of the method, apparatuses, and non-transitory computer-readable medium described herein, the fourth UE may be grouped with the second UE based on a beam configuration used to communicate with the fourth UE and the second UE.

Some examples of the method, apparatuses, and non-transitory computer-readable medium described herein may further include operations, features, means, or instructions for determining a third sidelink pathloss based on a third sidelink reference signal received from a fourth UE and transmitting, during the transmission time interval and using a radio frequency transmission chain that may be used to transmit the first sidelink transmission, a third sidelink transmission to the fourth UE using a third transmit power that may be based on the third sidelink pathloss.

Some examples of the method, apparatuses, and non-transitory computer-readable medium described herein may further include operations, features, means, or instructions for determining to use the first sidelink reference signal for determining the first sidelink pathloss based on a first beam used to communicate with the second UE and determining to use the second sidelink reference signal for determining the second sidelink pathloss based on a second beam used to communicate with the third UE.

Some examples of the method, apparatuses, and non-transitory computer-readable medium described herein may further include operations, features, means, or instructions for receiving based on the second UE and the third UE being configured within a same sidelink feedback channel group, a control message that indicates a first set of power control parameters to use to determine the first transmit power and a second set of power control parameters to use to determine the second transmit power.

In some examples of the method, apparatuses, and non-transitory computer-readable medium described herein, transmitting the first sidelink transmission and the second sidelink transmission may include operations, features, means, or instructions for transmitting a first sidelink feedback channel message using the first transmit power and a second sidelink feedback channel message using the second transmit power.

Some examples of the method, apparatuses, and non-transitory computer-readable medium described herein may further include operations, features, means, or instructions for adjusting a transmit power of a set of transmit powers corresponding to a set of sidelink feedback channel messages associated with a sidelink feedback channel group that includes the second UE and the third UE, the adjusting based on a transmit power constraint.

In some examples of the method, apparatuses, and non-transitory computer-readable medium described herein, adjusting the transmit power may include operations, features, means, or instructions for increasing or decreasing the transmit power based on a sidelink pathloss reference signal configuration at the first UE.

In some examples of the method, apparatuses, and non-transitory computer-readable medium described herein, adjusting the transmit power may include operations, features, means, or instructions for adjusting the transmit power within a range that may be defined by a minimum transmit power of the set of transmit powers and a maximum transmit power of the set of transmit powers.

Some examples of the method, apparatuses, and non-transitory computer-readable medium described herein may further include operations, features, means, or instructions for adjusting the transmit power based on a minimum, maximum, or average of each transmit power of the set of transmit powers.

In some examples of the method, apparatuses, and non-transitory computer-readable medium described herein, adjusting the transmit power may include operations, features, means, or instructions for identifying a highest priority sidelink transmission associated with the sidelink feedback channel group and adjusting the transmit power based on a second transmit power of the set of transmit powers, the second transmit power for a sidelink feedback channel message of the set of sidelink feedback channel messages that corresponds to the highest priority sidelink transmission.

Some examples of the method, apparatuses, and non-transitory computer-readable medium described herein may further include operations, features, means, or instructions for receiving, from a base station, an indication of a transmit power adjustment rule, where the transmit power may be adjusted in accordance with the transmit power adjustment rule.

Some examples of the method, apparatuses, and non-transitory computer-readable medium described herein may further include operations, features, means, or instructions for determining a remaining transmit power based on the first transmit power, the second transmit power, and a transmit power constraint and determining whether to transmit one or more additional sidelink transmissions based on the remaining transmit power.

In some examples of the method, apparatuses, and non-transitory computer-readable medium described herein, determining whether to transmit the one or more additional sidelink transmissions may include operations, features, means, or instructions for determining to not transmit the one or more additional sidelink transmissions based on the one or more additional sidelink transmissions being associated with a same priority and being associated with transmit powers that may be greater than the remaining transmit power.

In some examples of the method, apparatuses, and non-transitory computer-readable medium described herein, determining whether to transmit the one or more additional sidelink transmissions may include operations, features, means, or instructions for determining to transmit at least one of the one or more additional sidelink transmissions that may be associated with a same priority based on a resource block index, a subchannel index, a destination identifier, a priority of the destination identifier, or a combination thereof.

In some examples of the method, apparatuses, and non-transitory computer-readable medium described herein, determining whether to transmit the one or more additional sidelink transmissions may include operations, features, means, or instructions for determining to transmit at least one of the one or more additional sidelink transmissions that may be associated with a same priority based on a lowest transmit power associated with the at least one of the one or more additional sidelink transmissions.

In some examples of the method, apparatuses, and non-transitory computer-readable medium described herein, transmitting the first sidelink transmission and the second sidelink transmission may include operations, features, means, or instructions for transmitting, during the transmission time interval, a first sidelink control channel transmission and a second sidelink control channel transmission, a first sidelink shared channel transmission and a second sidelink shared channel transmission, or a first sidelink reference signal transmission and a second sidelink reference signal transmission.

Some examples of the method, apparatuses, and non-transitory computer-readable medium described herein may further include operations, features, means, or instructions for determining the first transmit power, the second transmit power, or both, based on a closed-loop power control procedure.

### BRIEF DESCRIPTION OF THE DRAWINGS

FIG. 1 illustrates an example of a wireless communications system that supports sidelink power control for multiplexed transmissions in accordance with aspects of the present disclosure.

FIG. 2 illustrates an example of a wireless communications system that supports sidelink power control for multiplexed transmissions in accordance with aspects of the present disclosure.

FIG. 3 illustrates an example of a wireless communications system that supports sidelink power control for multiplexed transmissions in accordance with aspects of the present disclosure.

FIG. 4 illustrates an example of a process flow that supports sidelink power control for multiplexed transmissions in accordance with aspects of the present disclosure.

FIGS. 5 and 6 show block diagrams of devices that support sidelink power control for multiplexed transmissions in accordance with aspects of the present disclosure.

FIG. 7 shows a block diagram of a communications manager that supports sidelink power control for multiplexed transmissions in accordance with aspects of the present disclosure.

FIG. 8 shows a diagram of a system including a device that supports sidelink power control for multiplexed transmissions in accordance with aspects of the present disclosure.

FIGS. 9 through 11 show flowcharts illustrating methods that support sidelink power control for multiplexed transmissions in accordance with aspects of the present disclosure.

### DETAILED DESCRIPTION

A wireless communications system may support communications between user equipments (UEs). Such communications may be sidelink communications. In sidelink communication scenarios, a first UE (transmitting UE) may transmit a message to a second UE (receiving UE), and the second UE may transmit feedback corresponding to the transmission. The feedback may indicate whether the second UE was able to successfully decode the transmission. In some cases, the second UE may utilize power control techniques to determine a transmission power for transmitting the feedback. The power control technique for transmitting sidelink feedback may utilize a pathloss between a base station and the second UE. However, such techniques may result in use of high transmission power, which may be wasteful or cause interference, or low transmission power, which may result in dropped transmissions.

Additionally, UEs may transmit multiple feedback transmissions that are frequency domain multiplexed (FDM). In such cases, a UE may use the same transmit power for each feedback transmission, even though the pathlosses between the UEs may be different, which may result in use of high or low transmission power. Some UEs may be configured to transmit frequency domain multiplexed transmissions with different transmission powers due to the UE being configured with (e.g., having, including) multiple radio frequency transmission chains (e.g., radio frequency transmission components), the UE having the digital domain capability of transmitting FDM transmissions with different powers, or both.

Techniques described herein support transmission of multiple sidelink communications in a FDM manner, while using different transmission powers for one or more of the multiple sidelink communications. In some examples, a first UE may determine a first sidelink pathloss between the first UE and a second UE and a second sidelink pathloss between the first UE and a third UE. These sidelink pathlosses may be determined using reference signals received from the respective UEs. The first UE may transmit respective feedback transmissions in a FDM manner while using different transmission powers that are determined using the respective pathlosses. As such, the first UE may use transmission powers configured based on the communication conditions between the UEs, which may result in increased communication efficiency and throughput.

According to techniques described herein, the UE may report a capability of supporting FDM transmissions with different powers. Further, the UE may be configured with sidelink transmission groups (e.g., groups of transmissions corresponding to UEs) that are used to determine pathlosses and respective transmission powers. The UE may also be configured to account for power variation limitations and power constraints for determining transmission powers. As described in further detail herein, the UE may utilize these techniques for sidelink feedback transmissions, sidelink control and data transmissions, and uplink and downlink control and data transmissions. These and other techniques are described in further detail with respect to the figures.

Aspects of the disclosure are initially described in the context of wireless communications systems. Aspects of the disclosure are further described with respect to a wireless communications system illustrating sidelink pathloss determinations and feedback transmissions, a wireless communications system illustrating transmission groups for transmission power control, and a process flow. Aspects of the disclosure are further illustrated by and described with reference to apparatus diagrams, system diagrams, and flowcharts that relate to sidelink power control for multiplexed transmissions.

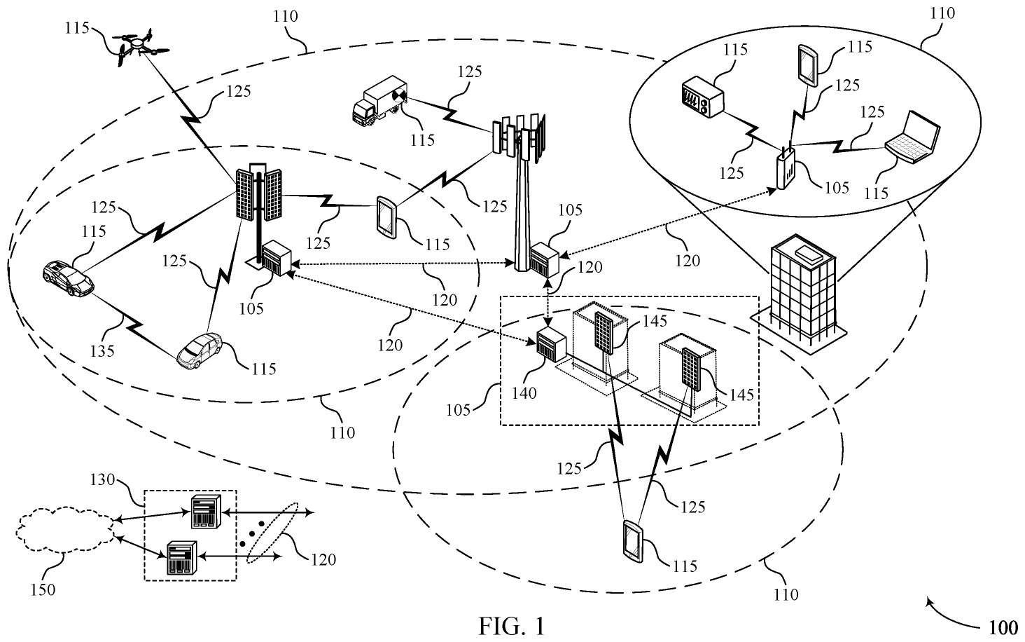

FIG. 1 illustrates an example of a wireless communications system 100 that supports sidelink power control for multiplexed transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

As described herein, the wireless communications system may support D2D communications between UEs 115. These communications between UEs 115 may be referred to as sidelink communications. For example, a first UE 115 may transmit a sidelink communication to a second UE 115. In response, the second UE 115 may transmit feedback corresponding to the sidelink communication. In some examples, the second UE may transmit multiple feedback transmissions to respective UEs 115 in a FDM manner in response to transmissions received from the other UEs. That is, the UE 115 may receive respective transmissions from two or more other UEs 115, and transmit the feedback transmissions to the two or more other UEs 115 such that each feedback transmission is transmitted at a respective frequency but during the same transmission time interval (TTI).

In such cases, the UE 115 transmitting the feedback transmissions may be configured to use the same transmission power for each of the feedback transmissions. The transmission power may be too high or too low for some UEs 115, which may result in wasted power, dropped transmissions, or interference in the wireless communications system 100.

Techniques described herein support the use of different transmission powers for different transmissions (e.g., different physical sidelink feedback channel (PSFCH) transmissions) that are transmitted in a FDM manner provided that the UE 115 is capable of transmitting FDM transmissions with different powers. In some cases, the UE 115 (first UE 115) may determine a first pathloss between the first UE 115 and a second UE 115 and a second pathloss between the first UE 115 and a third UE 115. The pathlosses may be determined using respective reference signals. The first UE 115 may use the pathlosses to determine transmit powers for respective transmissions to the second UE 115 and the third UE 115. The first UE 115 may transmit the respective transmissions in a FDM manner using the respective transmit powers. As such, the UE limit wasting power power and causing interfere with other communications using a transmit power that is too high and may limit the occurrence of dropped transmissions due to a transmission power that is too low.

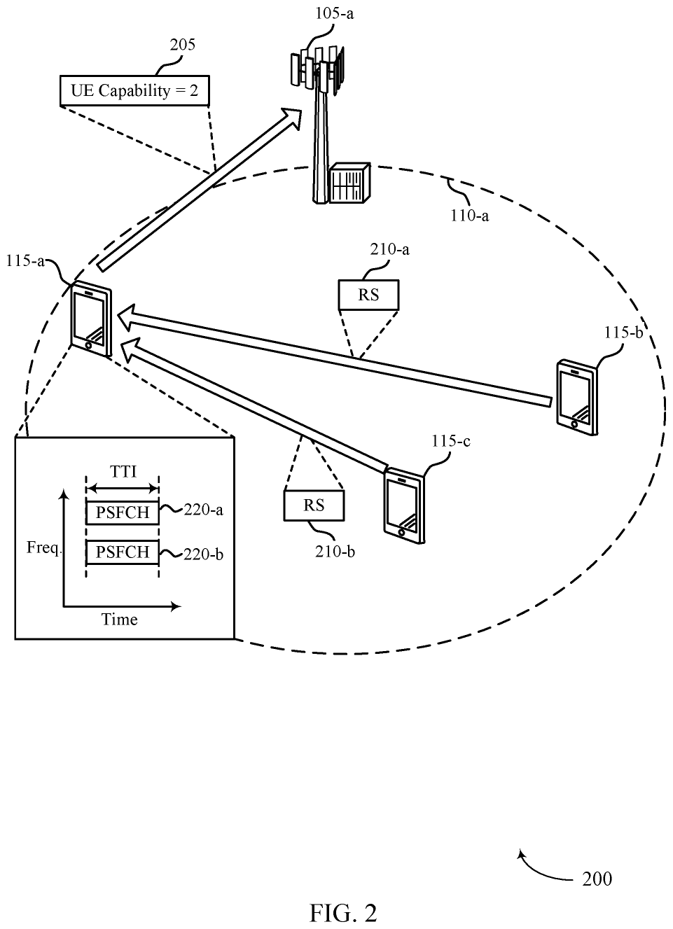

FIG. 2 illustrates an example of a wireless communications system 200 that supports sidelink power control for multiplexed transmissions in accordance with aspects of the present disclosure. The wireless communications system 200 may include aspects of wireless communications system 100 of FIG. 1. For example, the wireless communications system 200 includes a base station 105-a, a UE 115-a, a UE 115-b, and a UE 115-c, which may be examples of the corresponding devices described with respect to FIG. 1.

The base station 105-a may communicate with the UEs 115 that are positioned within a coverage area 110-a of the base station 105-a using various downlink and uplink communications. UEs 115 may be configured to communicate with one another via sidelink communications. In some examples, the sidelink communications between the UEs 115 are managed by the base station 105-a (e.g., mode 1 sidelink communications). In some examples, the sidelink communications between the UEs 115 may be performed without management by the base station 105-a (e.g., mode 2 sidelink communications). It should be understood that the sidelink communications between the UEs 115 may be performed by UEs 115 that are positioned within or outside the coverage area 110-a of the base station 105-a.

PSFCH transmissions 220, which are examples of sidelink transmissions, may be used to convey feedback to other UEs 115 in response to sidelink communications received from the other UEs 115. A PSFCH transmission 220 may carry a sidelink HARQ acknowledgement (ACK) or negative acknowledgement (NACK) from a physical sidelink shared channel (PSSCH) receiver to a PSSCH transmitter. For example, the UE 115-b may transmit a PSSCH message to the UE 115-a, and the UE 15-a may respond with PSFCH transmission 220-a that carries feedback corresponding to the PSSCH message. The HARQ feedback carried in a PSFCH transmission 220 may include one resource block (RB) on two OFDM symbols, wherein the first OFDM symbols is for automatic gain control (AGC). The UE 115-a may simultaneously FDM at most Nmax (e.g., UE capability) PSFCH transmissions 220. If Nsch PSFCHs are simultaneously scheduled, a procedure may be used to transmit Ntx≤min(Nsch, Nmax) PSFCHs, picking the highest priority PSFCHs while satisfying a total transmission power constraint Pcmax. The power setting for all the selected PSFCH may be equal, either based solely on the max power Pcmax and the number of PSFCH transmissions 220 to be sent, or based also on pathloss estimated via a downlink pathloss reference signal (e.g., transmitted by the base station 105-a to the UE 115-a).

In some examples, the UE 115 may determine the transmit powers for PSFCH as follows:
If downlink-based pathloss reference for PSFCH power-control (RRC parameter dl-P0-PSFCH) is not configured:
   Ntx=min(Nsch, Nmax) and all PSFCHs are sent with equal power such that the total power=Pcmax for PSFCH transmission.
Else (e.g., if dl-P0-PSFCH is configured):
   A nominal per-PSFCH power (called P_{PSFCH,one}) is computed based on Po, numerology, fractional pathloss alpha, and the downlink pathloss. The downlink pathloss is computed using the same pathloss-reference as used for power-control of PUSCHs scheduled with DCI-format 0_0, or if DCI-format 0_0 is not being monitored, the synchronization signal block (SSB) used to obtain the master information block (MIB).
   If Nsch>Nmax, then the UE selects the Nmax highest priority PSFCHs:
      If P_{PSFCH,one}*Nmax≤Pcmax, then Ntx=Nmax and each PSFCH is given the nominal power P_{PSFCH,one}.
   Else, select the PSFCHs in decreasing priority level until no more can be selected maintaining the total power to be ≤Pcmax (when each one is allotted the nominal power). Note that all PSFCHs of a given priority may be selected before going to the next priority level. If this technique violates the Pcmax constraint, then all of the PSFCHs of the priority are dropped.
Else (e.g., if Nsch≤Nmax):
   Send all Nsch scheduled PSFCH at nominal power if this meets the max power constraint. For example, if P_{PSFCH,one}*Nsch≤Pcmax, then Ntx=Nsch, each PSFCH power=P_{PSFCH,one}.
   Otherwise, select PSFCHs in decreasing priority just as in the Nsch>Nmax case as explained above.

Thus, the sidelink transmission power may be based on the downlink pathloss in such examples. The downlink pathloss may, however, be much higher than the sidelink pathloss. As such, a scheme as outlined immediate above may in some cases be power-inefficient, wasting both the battery and system resources of the UEs 115 (by causing interference to other sidelink receivers). These inefficiencies may be enhanced in mmW communications, where the pathloss may be beam-dependent.

In some examples, unlike the base station 105-a, the UE 115-a may not be capable of frequency domain multiplexing multiple transmissions with different power levels. Power settings in the analog section (baseband, intermediate frequency (IF), radio frequency (RF)) of the UE 115-a may apply to the entire transmit waveform such as to impact all the frequency domain multiplexed PSFCH transmissions 220. Thus, different power levels may be either created in the digital domain prior to digital-to-analog conversion, or separate analog transmit chains are to be used for different frequency domain multiplexed PSFCH messages, in which case each chain may set a transmit power independently. However, not all UEs 115 have such separate analog transmit chains. Also, there may be a limit to the power disparity that can be created in the digital domain, which depends on the bitwidth used at the UE 115. Too high disparity may result in clipping/saturation of the higher power PSFCH tones and/or underflow or zeroing-out of the lower power PSFCH tones. This may violate RF specifications such as adjacent channel leakage ratio (ACLR) and error vector magnitude (EVM).

However, in some cases, the UE 115-a may be capable of supporting communications with different transmission powers and that are frequency domain multiplexed. Techniques described herein may leverage such capability to improve communication efficiency, reliability, and throughput in the wireless communications system 200. UE 115-a may transmit an indication of the FDM capability to the base station 105-a or the other UEs 115-b and 115-c. For example, the UE 115-a sends a UE capability message 205 to the base station 105-a. The UE capability message 205 may indicate that the UE 115-a is capable of supporting two (e.g., UE capability=2) FDM transmissions with different transmission powers. Thus, this UE capability message 205 may indicate the number of transmission chains at the UE 115-a. Transmission chain may refer to one or more of antenna panel, associated beamforming controller, RF, IF, or analog baseband module, digital-to-analog convertor, and/or digital baseband processing such as an Inverse Fast Fourier Transform (IFFT) engine.

Such capability may have been used in other contexts (e.g., in links with the base station 105-a). However the capability described herein (e.g., UE capability message 205) may refer to capability for different transmission chains that can be used to transmit different frequency domain multiplexed signals, such as the PSFCH. However, these techniques may be applicable to other channels such as other Uu or sidelink channels. Thus, according to the techniques described herein, the frequency domain multiplexed PSFCH transmission 220 using one chain may have the same power, while the PSFCH transmissions 220 on different chains may have independent powers.

As described herein, transmission chains may be motivated by hardware constraints, but these constraints may not be explicitly reported or used. For example, instead of using “transmission chain,” the UE 115-a may report or the techniques may be based on a “PSFCH group,” as described in further detail herein. A PSFCH group may be used in context of sidelink carrier aggregation, as a group of sidelink component carriers for which the feedback (PSFCH) is carried on a specific component carriers. Here, the PSFCH group refers to a group of PSFCHs such that any two PSFCHs may within a group may have the same transmit power if they are frequency domain multiplexed. As such, the PSFCH groups may be formed separately per sidelink component carrier or bandwidth part, or may span multiple component carriers or bandwidth parts.

As describe, the UE 115-a may report its capability (e.g., the number of supported PSFCH groups) using the UE capability message 205. Additionally, the base station 105-a may configure the groups at the UE 115-a. The groups may be radio resource control (RRC) configured, or updated more dynamically by MAC-CE or DCI, or using sidelink control messages, such as, SL-RRC, SL-MAC-CE, or sidelink control information (SCI). In some examples, a PSFCH group may depend implicitly or explicitly on the beam used for PSFCH. For example, PSFCH transmissions on the same beam or same panel may be configured in the same PSFCH-group. A PSFCH group may correspond to one or more UEs that are configured in each group. As such, if the UE 115-a communicates with two other UEs 115 using the same beam/panel, then the two other UEs 115 may be configured in the same group.

As described herein, the nominal transmit power may depend on the downlink pathloss between the base station 105-a and the UE 115-a. The techniques described herein may use the sidelink pathloss or the minimum of a downlink and sidelink pathloss.

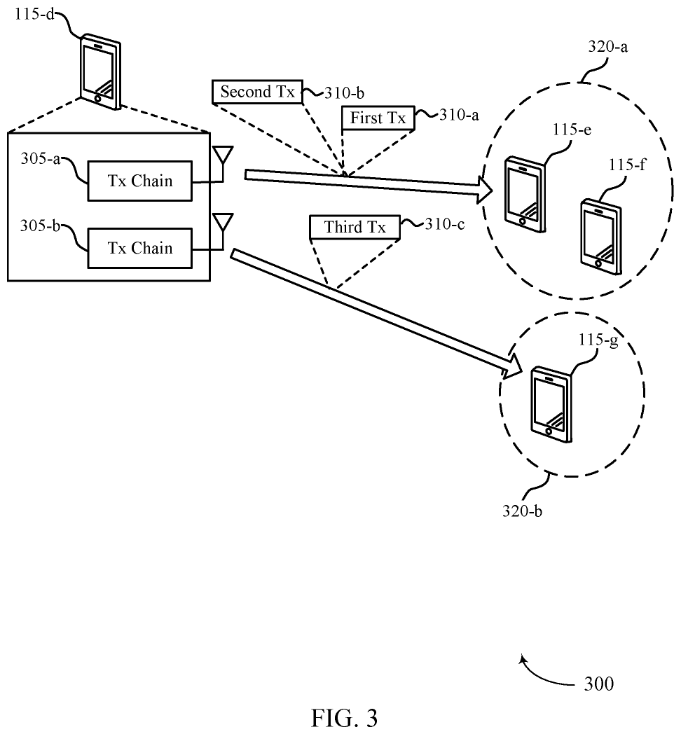

A common sidelink pathloss reference signal 210 may be assigned for each PSFCH in a single PSFCH group, but different groups may have different sidelink pathloss reference signals 210. For example, if the UE 115-b corresponds to a first PSFCH group and the UE 115-c corresponds to a second PSFCH group for the UE 115-a (e.g., as configured by the base station 105-a), then the UE 115-a may use respective sidelink pathloss reference signals 210 to determine the respective pathlosses for the UEs 115-b and 115-c. Thus, using the techniques described herein, the UE 115-a may determine a first pathloss between the UE 115-a and the UE 115-b using the sidelink pathloss reference signal 210-a. The UE 115-a may also determine a second pathloss between the UE 115-a and the UE 115-c using the sidelink pathloss reference signal 210-b. The UE may use the first and second pathlosses to determine first and second transmission powers for the PSFCH transmissions 220-a and 220-b. Thus, the UE 115-a may transmit the first PSFCH transmission 220-a to the UE 115-b using a first transmit power that is based on the first sidelink pathloss and the second PSFCH transmission 220-b to the UE 115-c using a second transmit power that is based on the second sidelink pathloss. The first PSFCH transmission 220-a and the second PSFCH transmission 220-b may be transmitted in a FDM manner (e.g., on different frequencies but during the same transmission time interval (TTI)), as illustrated. In some examples, the first PSFCH transmission 220-a is transmitted using a first transmission chain at the UE 115-a and the second PSFCH transmission 220-b is transmitted using a second transmission chain at the UE 115-b. In some examples, as described in further detail with respect to FIG. 3, the UE 115-a may transmit the PSFCH transmissions 220-a and 220-b with different transmit powers but using the same transmission chain.

FIG. 3 illustrates an example of a wireless communications system 300 that supports sidelink power control for multiplexed transmissions in accordance with aspects of the present disclosure. The wireless communications system 300 may include aspects of wireless communications systems 100 and 200 of FIGS. 1 and 2. For example, the wireless communications system 300 includes a UE 115-d, a UE 115-e, a UE 115-f, and a UE 115-g, which may be examples of the UEs 115 described with respect to FIGS. 1 and 2. The wireless communications system 300 may also include a base station, such as base stations 105 described with respect to FIGS. 1 and 2.

The UE 115-d may support frequency domain multiplexed transmissions with different transmit powers based on the UE 115-d may configured with multiple transmission chains 305 (e.g., a radio frequency transmission chain). Each transmission chain 305 may include an antenna panel, an associated beamforming control, RF, IF, or analog base band module, digital-to-analog convertor, digital base band processing units (e.g., IFFT engine), or a combination thereof. As described with respect to FIG. 2, the UE 115-d may report its capability (e.g., the number of transmission chains or the number of supported PSFCH groups) to a base station 105 and/or the other UEs 115. In this example, the capability may be reported as N=2).

As described herein, the UE 115-d may be configured with PSFCH groups 320, which may correspond to UEs 115 that are in the respective groups. For example, the UE 115-d may receive a control message (e.g., from a base station 105) that indicates a mapping of UEs 115 to the PSFCH groups 320. Thus, the control message may map the UE 115-e and the UE 115-f to the PSFCH group 320-a and the UE 115-g to the PSFCH group 320-b. In some cases, the mappings are indicated implicitly, such as based on the beam that is used to communicate with the respective UEs 115. For example, a common reference signal could correspond to a broad beam that covers each of the individual transmission beams in the PSFCH group 320-a. The configuration of PSFCH groups may also indicate the pathloss reference signals that are to be used to determine transmit powers for transmissions to the respective groups. Thus, a first sidelink pathloss reference signal may be used for the PSFCH group 320-a, and a second pathloss reference signal may be used for the PSFCH group 320-b. For the PSFCH group 320-a, the UE 115-d may be configured to use one reference signal of reference signals transmitted by each of the UEs 115-e and 115-f.

The UE 115-d may use the reference signals to determine the transmit powers and transmit a first transmission 310-a and second transmission 310-b to the UEs 115-e and 115-f of the PSFCH group 320-a and a third transmission 310-c to the UE 115-g of the PSFCH group 320-b. The transmissions 310 may be examples of sidelink transmissions. The first transmission 310-a and the second transmission 310-b may be transmitted using a same transmit power because the transmissions 310-a and 310-b are transmitted to UEs 115 in the same PSFCH group 320-a and using the same transmission chain 305-a. The third transmission 310-c may be transmitted using a different transmission power. The first transmission 310-a, the second transmission 310-b, and the third transmission 310-c may be transmitted in a FDM manner (e.g., using different frequencies but during the same TTI). In some cases, each transmission 310 is a PSFCH. In other cases, each transmission 310 is a PSSCH or physical sidelink control channel (PSCCH) transmission.

In some examples, the UE 115-d may support transmission power variations for frequency domain multiplexed transmissions within one transmission chain 305. This may be due to the UE 115-d having a high analog-to-digital bitwidth, where the UE 115-d supports any amount of power-variation across frequency domain multiplexed signals. If the digital processing components of the UE 115-d have sufficiently high bitwidth, the power variations across frequency domain multiplexed transmissions PSFCHs could be created entirely in the digital domain even if one transmission chain 305 is used, while still meeting all the relevant radio frequency specifications. In such cases, the UE 115-d can be assigned a separate sidelink pathloss reference signals, and/or other sidelink power-control parameters, for each PSFCH or transmission within the group. For example, the UE 115-d may be assigned and use different sidelink pathloss reference signals for determining the transmit power for the first transmission 310-a to the UE 115-e and for determining the transmit power for the second transmission 310-b to the UE 115-f, even though the first transmission 310-a and the second transmission 310-b are frequency domain multiplexed and transmitted using the same transmission chain 305-a.

In such cases, the nominal power P_{PSFCH,one} may now be different per PSFCH transmission (e.g., transmission 310), and when accounting for a maximum power constraint, the expression P_{PSFCH,one}*N is replaced by the sum of all the nominal powers of the N relevant selected PSFCHs.

If the UE 115-d has moderate analog-to-digital bitwidth capability, the UE 115-d may support limited power-variation across frequency domain multiplexed signals. In such cases, the UE 115-d may still be assigned separate sidelink power control parameters per PSFCH transmission. However, in some cases, frequency domain multiplexing may not be possible while still meeting the radio frequency constraints due to overflow/underflow. Thus, the power-control procedure may be adjusted to account for these cases. In such cases, the transmit power may be first computed as described herein, but the computed power may be adjusted. In such cases, the adjustment may be left to the UE 115-d, subject to various rules, such as to satisfy maximum permittable exposure (MPE) limits or other limits or constraints.

According to one adjustment rule, the UE 115-a may be allowed increase the power, decrease the power, or both. What is allowed may depend on the pathloss-reference signal (PLrefRS) configured for the PSFCH. For example, if both downlink and sidelink PLrefRS is configured, then power may be increased (and not decreased), whereas if only the downlink PLrefRSis configured, power may be decreased (and not increased). Additionally or alternatively (e.g., according to the same or another rule), the amount of power adjustment is limited by the difference between the transmit powers as computed. For example, with three frequency domain multiplexed PSFCHs with powers P1<P2<P3, all adjusted powers must lie in the range [P1, P3]. According to another possible rule, the UE 115-d may use the transmit power of the PSFCH associated with highest priority PSSCH. For example, if the UE receives a first PSSCH from the UE 115-e and a second PSSCH from the UE 115-f, then the UE 115-d may use the transmit power computed for the PSFCH corresponding to the highest priority PSSCH of the first and second PSSCH. Thus, each PSFCH may use the same transmit power, and as such, the UE 115-d adjusts the one of the transmit powers accordingly.

According to another possible transmit power adjustment rule, if multiple PSFCH groups 320 are configured, the adjustments described herein may be allowed within each PSFCH group 320. According to this rule, if three frequency domain multiplexed PSFCHs were on different PSFCH groups 320 and each group is allocated one of the PSFCHs, no adjustment would be allowed. In some cases, the rules that are used for adjustment may be configured at the UE 115-d or configured as a list of possible rules, where one or more rules are indicated via control signaling.

According to some techniques, when a portion of the scheduled PSFCHs can be transmitted due to total power (Pcmax) limitations, if any PSFCH is transmitted, then other PSFCHs with the same priority are also transmitted. This technique may result in some leftover power. For example, one or more PSFCH transmission with the next lower priority could have been transmitted meeting Pcmax, but because there were two such PSFCHs with that same priority, and transmitting both of them would meet the Pcmax limit, they would both be dropped.

According to techniques described herein, the UE 115-d may be configured to transmit some of the PSFCHs of a given priority. Which of these PSFCHs should be sent may be left to UE 115-d implementation, or could be decided based on a tie breaker rule. Example rules may be based on lowest or highest resource block index, subchannel-index, destination identifier, highest priority destination identifier, or the like. If frequency domain multiplexed PSFCH messages are allowed to have different powers, the rule could also be based on the transmission power of the PSFCH. For example, the UE 115-d may prioritize the PSFCH that uses minimum transit power, so as to be able to transmit the maximum number of additional PSFCHs. In such cases, the UE 115-d may consider remaining transmission power after transmission powers are applied to a number of PSFCH with the same priority, then use the remaining transmission power to transmit a maximum number of remaining PSFCHs.

As noted, the techniques described herein may be applied to frequency domain transmissions, other than PSFCH messages, by the UE 115-d. The techniques are applicable to PSFCH messages because PSFCH occasions within a resource pool may be frequency domain multiplexed on the same pair of OFDM symbols, and UE 115-d may be configured to transmit a number of frequency domain multiplexed PSFCHs. Further, scheduling to avoid frequency domain multiplexing of PSFCHs may be complex in some situations.

In the case of frequency domain multiplexed PSSCHs, the UE 115-d may choose to avoid frequency domain multiplexing, if the UE 115-d cannot maintain the power-differential, by dropping one or more of the PSSCH transmissions. Sidelink grants may not enforce what the UE 115-d is or is not to transmit. The sidelink grants from the base station (in mode 1) may be based on a sidelink buffer status report (BSR), and UE 115-d may be able to adjust its sidelink BSR reports so as to receive grants in a time domain multiplexed manner rather than a frequency domain multiplexed manner.

In another alternative, to allow the UE 115-d to be able to frequency domain multiplex without being limited by the difficulties of frequency domain multiplexed signals of different transmit powers, the transmit power control equations or procedures for other channels (PSSCH or PSCCH) may be modified in the same or similar manner as described above for the case of PSFCHs. For PSSCH/PSCCH, the UE 115-d may support being configured one or both of sidelink and downlink PLrefRS. The techniques described herein may support adjustment of the resulting computed transmit powers as described above for PSSCH or PSCCH transmissions that are frequency domain multiplexed. The capabilities discussed earlier related to PSFCH groups 320 and analog-to-digital components may be indicated separately for each physical channel, reference signal, or combination or group of physical channels or reference signals. These techniques may also be extended to other sidelink physical channels or reference signals, such as such as CSI-RS (standalone or embedded in PSSCH), tracking reference signal (TRS), positioning reference signal (PRS), sounding reference signal (SRS), and also to frequency domain multiplexing of Uu signals with sidelink physical channels or reference signals.

Additionally, the techniques described herein may be based on open-loop power control procedures in sidelink communication scenarios. However, it should be understood that the techniques may also be applicable to closed-loop power control procedures in sidelink communications. Thus, the closed-loop power control procedure in sidelink may support different PSFCHs to have different transmit powers. In the case of use of these techniques for frequency domain multiplexed uplink and sidelink signals, the uplink channel may have closed-loop power control.

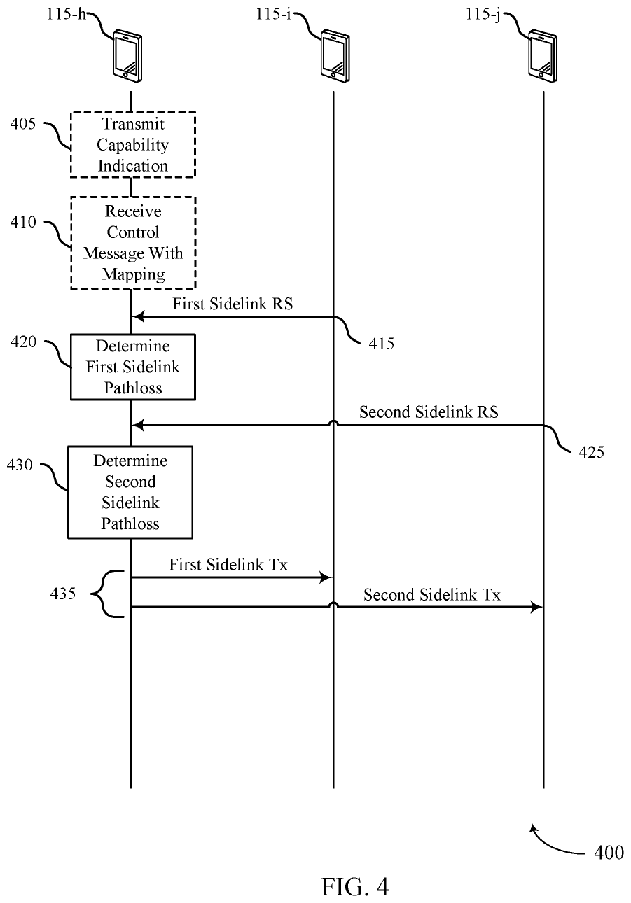

FIG. 4 illustrates an example of a process flow 400 that supports sidelink power control for multiplexed transmissions in accordance with aspects of the present disclosure. The process flow 400 may be implemented by aspects of the wireless communications systems 100, 200, and 300 as described with respect to FIGS. 1 through 3. The process flow 400 includes a first UE 115-h, a second UE 115-i, and a third UE 115-j, which may be examples of the UEs 115 as described with respect to FIGS. 1 through 3.

The process flow 400 illustrates an exemplary order of actions performed by the UE 115-h, the UE 115-i, and the UE 115-j to perform sidelink communications. In the following description of the process flow 400, the operations between the UE 115-h, the UE 115-i, and the UE 115-j may be transmitted in a different order than the exemplary order shown, or the operations performed by the UE 115-h, the UE 115-i, and the UE 115-j may be performed in different orders or at different times. Some operations may also be omitted from the process flow 400, and/or other operations may be added to the process flow 400.

At 405, the first UE 115-h may transmit, to a base station (e.g., base station 105 as described with respect to FIGS. 1 and 2), an indication that the first UE 115-h is capable of transmitting a quantity of frequency domain multiplexed transmissions with different transmit powers. In some cases, the quantity may be based on a number of transmission chains configured at the first UE 115-h.

At 410, the first UE 115-h may receive a control message that indicates a mapping of the second UE 115-i to a first sidelink feedback channel group and of the third UE 115-j to a second sidelink feedback channel group. In some cases, the control message is received from a base station or another UE 115. The mapping may be indicated based on beams used to communicate with respective UEs 115.

At 415, the first UE 115-h may receive a first sidelink reference signal from the second UE 115-i. The first sidelink reference signal may be configured at the first UE 115-h by a base station (e.g., based on the configured PSFCH group).

At 420, the first UE 115-h may determine a first sidelink pathloss based at least in part on the first sidelink reference signal received from the second UE 115-h.

At 425, the first UE 115-h may receive a second sidelink reference signal from the third UE 115-j. The second sidelink reference signal may be configured at the first UE-h by a base station (e.g., based on the configured PSFCH group).

At 430, the first UE 115-h may determine a second sidelink pathloss based at least in part on the second sidelink reference signal received from the third UE 115-j.

At 435, the first UE 115-h may transmit, during a transmission time interval, a first sidelink transmission to the second UE 115-i using a first transmit power that is based at least in part on the first sidelink pathloss and a second sidelink transmission to the third UE 115-j using a second transmit power that is based at least in part on the second sidelink pathloss. The first sidelink transmission may be transmitted at a first frequency, and the second sidelink transmission may be transmitted at a second frequency, such that the first and second sidelink transmissions are frequency domain multiplexed. The first and second transmit powers may be determined using open or closed loop transmission power control procedures described herein.

In some examples, the first and second sidelink transmission are transmitted using different transmit chains, allowing the different transmit powers to be used. However, in some examples, the first and second sidelink transmissions may be transmitted using the same transmit chain at the UE 115-h. In such cases, the UE 115-h may perform various adjustments to the transmit powers in order to satisfy transmission power constraints. The UE 115-a may adjust the transmit power based on a rule indicated by the base station. For example, the second UE 115-i and the third UE 115-j may be configured in the same sidelink feedback channel group at the first UE 115-h. In such cases, the first UE 115-h may increase or decrease a transmit power based on a sidelink pathloss reference signal configuration at the first UE 115-h (e.g., based on whether one or both of the downlink and sidelink pathloss reference signals are configured). In some examples, the first UE 115-h may adjust the transmit power within a range that is defined by a minimum transmit power of a set of transmit powers and a maximum transmit powers of the set of transmit powers, wherein the set of transmit powers corresponds to transmit powers computed for each transmission within a group. The first UE 115-h may also adjust the transmit power based on a minimum, maximum, or average of each transmit power of the set of transmit powers. In some cases, the first UE 115-h h may adjust the transmit power based on a highest priority sidelink transmission associated with the sidelink feedback channel group. The first UE 115-h may also determine a remaining transmit power and determine to transmit some or all remaining transmissions based on the remaining transmit power.

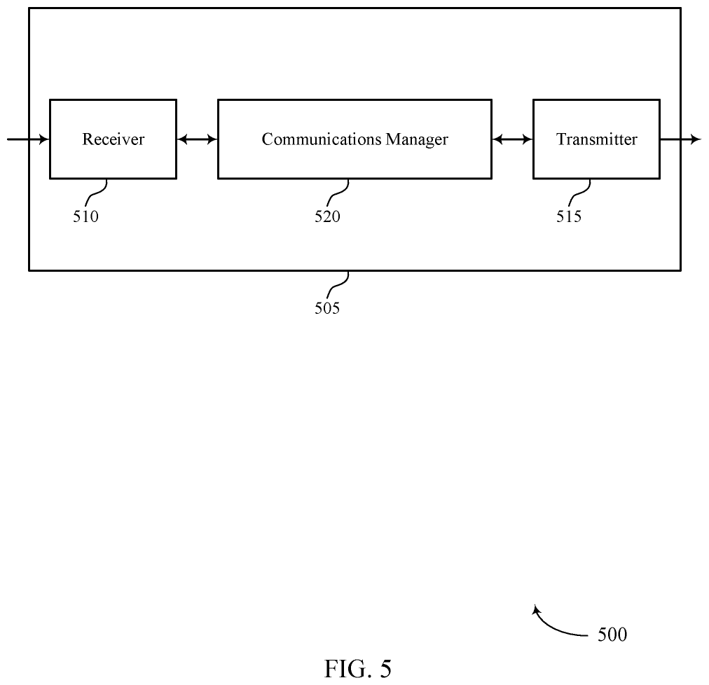

FIG. 5 shows a block diagram 500 of a device 505 that supports sidelink power control for multiplexed transmissions in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to sidelink power control for multiplexed transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sidelink power control for multiplexed transmissions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of sidelink power control for multiplexed transmissions as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may be configured to receive or transmit messages or other signaling as described herein via the transceiver 815. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a first UE in accordance with examples as disclosed herein. For example, the communications manager 520 may be configured as or otherwise support a means for determining a first sidelink pathloss based on a first sidelink reference signal received from a second UE. The communications manager 520 may be configured as or otherwise support a means for determining a second sidelink pathloss based on a second sidelink reference signal received from a third UE. The communications manager 520 may be configured as or otherwise support a means for transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption and more efficient utilization of communication resources based on determining transmit powers for respective sidelink communications that are frequency domain multiplexed.

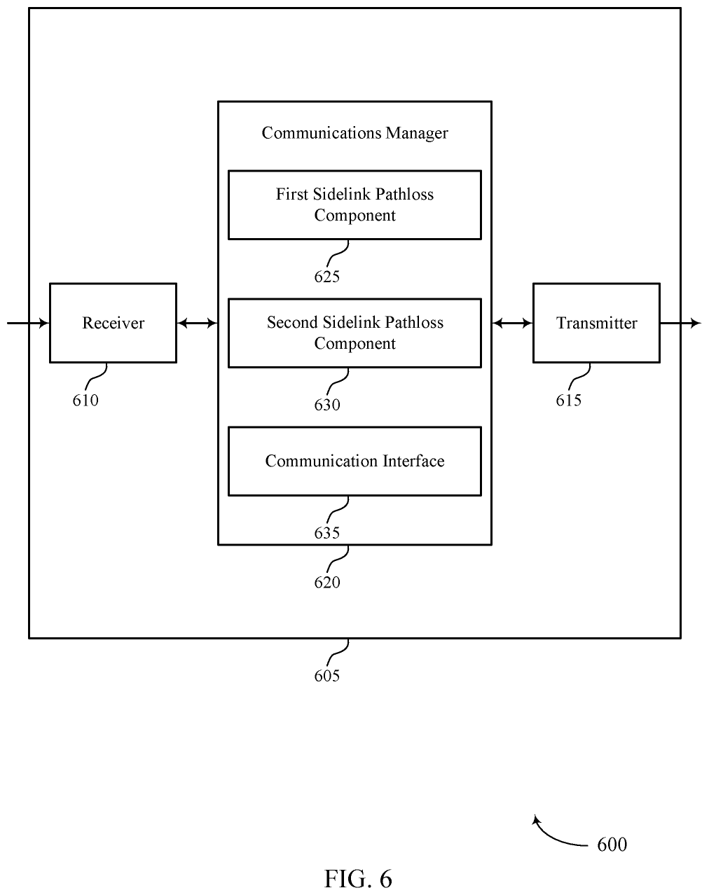

FIG. 6 shows a block diagram 600 of a device 605 that supports sidelink power control for multiplexed transmissions in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink power control for multiplexed transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink power control for multiplexed transmissions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of sidelink power control for multiplexed transmissions as described herein. For example, the communications manager 620 may include a first sidelink pathloss component 625, a second sidelink pathloss component 630, a communication interface 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a first UE in accordance with examples as disclosed herein. The first sidelink pathloss component 625 may be configured as or otherwise support a means for determining a first sidelink pathloss based on a first sidelink reference signal received from a second UE. The second sidelink pathloss component 630 may be configured as or otherwise support a means for determining a second sidelink pathloss based on a second sidelink reference signal received from a third UE. The communication interface 635 may be configured as or otherwise support a means for transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

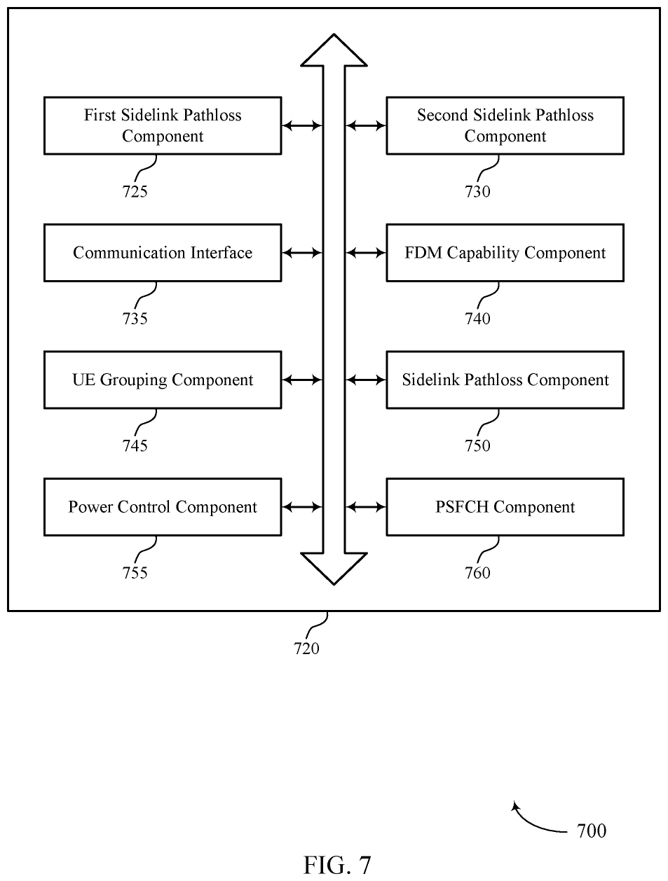

FIG. 7 shows a block diagram 700 of a communications manager 720 that supports sidelink power control for multiplexed transmissions in accordance with aspects of the present disclosure. The communications manager 720 may be an example of aspects of a communications manager 520, a communications manager 620, or both, as described herein. The communications manager 720, or various components thereof, may be an example of means for performing various aspects of sidelink power control for multiplexed transmissions as described herein. For example, the communications manager 720 may include a first sidelink pathloss component 725, a second sidelink pathloss component 730, a communication interface 735, an FDM capability component 740, a UE grouping component 745, a sidelink pathloss component 750, a power control component 755, an PSFCH component 760, or any combination thereof. Each of these components may communicate, directly or indirectly, with one another (e.g., via one or more buses).

The communications manager 720 may support wireless communications at a first UE in accordance with examples as disclosed herein. The first sidelink pathloss component 725 may be configured as or otherwise support a means for determining a first sidelink pathloss based on a first sidelink reference signal received from a second UE. The second sidelink pathloss component 730 may be configured as or otherwise support a means for determining a second sidelink pathloss based on a second sidelink reference signal received from a third UE. The communication interface 735 may be configured as or otherwise support a means for transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

In some examples, the FDM capability component 740 may be configured as or otherwise support a means for transmitting, to a base station, an indication that the first UE is capable of transmitting a quantity of frequency domain multiplexed transmissions with different transmit powers, where the first UE transmits the first sidelink transmission using the first transmit power and the second sidelink transmission using the second transmit power based on transmitting the indication.

In some examples, the first UE is capable of transmitting frequency domain multiplexed transmissions with different transmit powers based on the first UE being configured with two or more radio frequency transmission chains.

In some examples, the first UE is capable of transmitting frequency domain multiplexed transmissions with different transmit powers using a single radio frequency transmission chain.

In some examples, the UE grouping component 745 may be configured as or otherwise support a means for receiving a control message that indicates a mapping of the second UE to a first sidelink feedback channel group and of the third UE to a second sidelink feedback channel group, where the first UE transmits a first sidelink feedback channel message as the first sidelink transmission using the first transmit power and a second sidelink feedback channel message as the second sidelink transmission using the second transmit power based on receiving the control message that indicates the mapping.

In some examples, to support receiving the control message, the UE grouping component 745 may be configured as or otherwise support a means for receiving, from a base station, a radio resource control message, a medium access control layer control element message, or a downlink control information message that indicates the mapping.

In some examples, to support receiving the control message, the UE grouping component 745 may be configured as or otherwise support a means for receiving, from the second UE, the third UE, or both, a sidelink radio resource control message, a sidelink medium access control layer control element message, or a sidelink control information message that indicates the mapping.

In some examples, to support receiving the control message, the UE grouping component 745 may be configured as or otherwise support a means for receiving an indication that the first sidelink reference signal is to be used for determining the first sidelink pathloss and the second sidelink reference signal is to be used for determining the second sidelink pathloss.

In some examples, the communication interface 735 may be configured as or otherwise support a means for transmitting, to a fourth UE during the transmission time interval, a third sidelink feedback channel message using the first transmit power that is based on the first sidelink pathloss in accordance with the fourth UE being grouped with the second UE for sidelink feedback channel transmission.

In some examples, the fourth UE is grouped with the second UE based on a beam configuration used to communicate with the fourth UE and the second UE.

In some examples, the sidelink pathloss component 750 may be configured as or otherwise support a means for determining a third sidelink pathloss based on a third sidelink reference signal received from a fourth UE. In some examples, the communication interface 735 may be configured as or otherwise support a means for transmitting, during the transmission time interval and using a radio frequency transmission chain that is used to transmit the first sidelink transmission, a third sidelink transmission to the fourth UE using a third transmit power that is based on the third sidelink pathloss.

In some examples, the first sidelink pathloss component 725 may be configured as or otherwise support a means for determining to use the first sidelink reference signal for determining the first sidelink pathloss based on a first beam used to communicate with the second UE. In some examples, the second sidelink pathloss component 730 may be configured as or otherwise support a means for determining to use the second sidelink reference signal for determining the second sidelink pathloss based on a second beam used to communicate with the third UE.

In some examples, the power control component 755 may be configured as or otherwise support a means for receiving, based on the second UE and the third UE being configured within a same sidelink feedback channel group, a control message that indicates a first set of power control parameters to use to determine the first transmit power and a second set of power control parameters to use to determine the second transmit power.

In some examples, to support transmitting the first sidelink transmission and the second sidelink transmission, the PSFCH component 760 may be configured as or otherwise support a means for transmitting a first sidelink feedback channel message using the first transmit power and a second sidelink feedback channel message using the second transmit power.

In some examples, the power control component 755 may be configured as or otherwise support a means for adjusting a transmit power of a set of transmit powers corresponding to a set of sidelink feedback channel messages associated with a sidelink feedback channel group that includes the second UE and the third UE, the adjusting based on a transmit power constraint.

In some examples, to support adjusting the transmit power, the power control component 755 may be configured as or otherwise support a means for increasing or decreasing the transmit power based on a sidelink pathloss reference signal configuration at the first UE.

In some examples, to support adjusting the transmit power, the power control component 755 may be configured as or otherwise support a means for adjusting the transmit power within a range that is defined by a minimum transmit power of the set of transmit powers and a maximum transmit power of the set of transmit powers.

In some examples, the power control component 755 may be configured as or otherwise support a means for adjusting the transmit power based on a minimum, maximum, or average of each transmit power of the set of transmit powers.

In some examples, to support adjusting the transmit power, the power control component 755 may be configured as or otherwise support a means for identifying a highest priority sidelink transmission associated with the sidelink feedback channel group. In some examples, to support adjusting the transmit power, the power control component 755 may be configured as or otherwise support a means for adjusting the transmit power based on a second transmit power of the set of transmit powers, the second transmit power for a sidelink feedback channel message of the set of sidelink feedback channel messages that corresponds to the highest priority sidelink transmission.

In some examples, the communication interface 735 may be configured as or otherwise support a means for receiving, from a base station, an indication of a transmit power adjustment rule, where the transmit power is adjusted in accordance with the transmit power adjustment rule.

In some examples, the power control component 755 may be configured as or otherwise support a means for determining a remaining transmit power based on the first transmit power, the second transmit power, and a transmit power constraint. In some examples, the communication interface 735 may be configured as or otherwise support a means for determining whether to transmit one or more additional sidelink transmissions based on the remaining transmit power.

In some examples, to support determining whether to transmit the one or more additional sidelink transmissions, the communication interface 735 may be configured as or otherwise support a means for determining to not transmit the one or more additional sidelink transmissions based on the one or more additional sidelink transmissions being associated with a same priority and being associated with transmit powers that are greater than the remaining transmit power.

In some examples, to support determining whether to transmit the one or more additional sidelink transmissions, the communication interface 735 may be configured as or otherwise support a means for determining to transmit at least one of the one or more additional sidelink transmissions that are associated with a same priority based on a resource block index, a subchannel index, a destination identifier, a priority of the destination identifier, or a combination thereof.

In some examples, to support determining whether to transmit the one or more additional sidelink transmissions, the communication interface 735 may be configured as or otherwise support a means for determining to transmit at least one of the one or more additional sidelink transmissions that are associated with a same priority based on a lowest transmit power associated with the at least one of the one or more additional sidelink transmissions.

In some examples, to support transmitting the first sidelink transmission and the second sidelink transmission, the communication interface 735 may be configured as or otherwise support a means for transmitting, during the transmission time interval, a first sidelink control channel transmission and a second sidelink control channel transmission, a first sidelink shared channel transmission and a second sidelink shared channel transmission, or a first sidelink reference signal transmission and a second sidelink reference signal transmission.

In some examples, the power control component 755 may be configured as or otherwise support a means for determining the first transmit power, the second transmit power, or both, based on a closed-loop power control procedure.

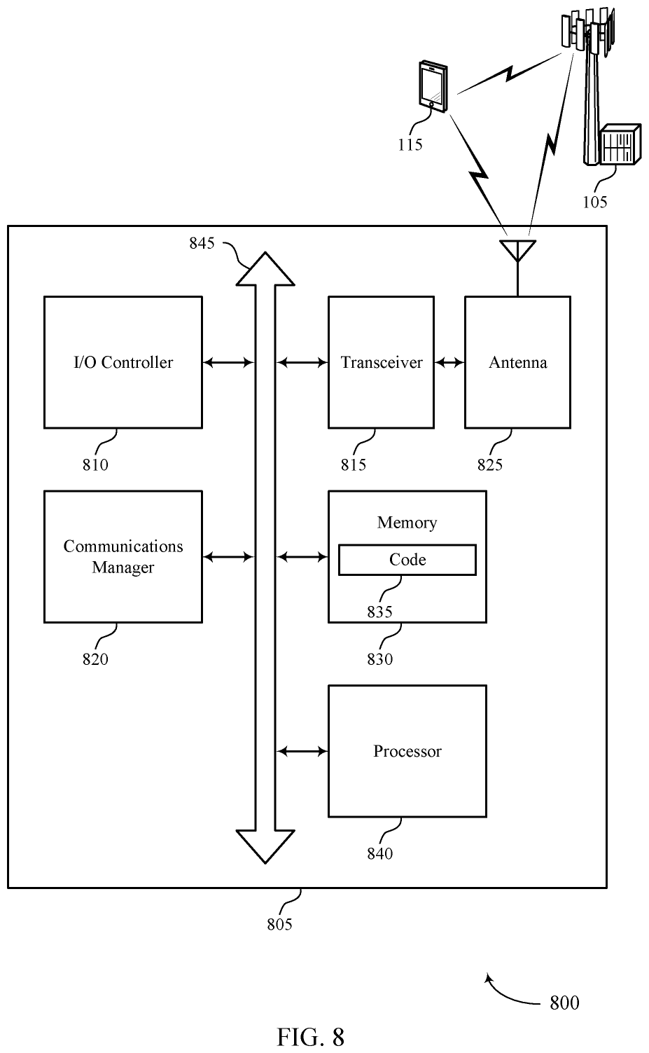

FIG. 8 shows a diagram of a system 800 including a device 805 that supports sidelink power control for multiplexed transmissions in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting sidelink power control for multiplexed transmissions). For example, the device 805 or a component of the device 805 may include a processor 840 and memory 830 coupled with the processor 840, the processor 840 and memory 830 configured to perform various functions described herein.

The communications manager 820 may support wireless communications at a first UE in accordance with examples as disclosed herein. For example, the communications manager 820 may be configured as or otherwise support a means for determining a first sidelink pathloss based on a first sidelink reference signal received from a second UE. The communications manager 820 may be configured as or otherwise support a means for determining a second sidelink pathloss based on a second sidelink reference signal received from a third UE. The communications manager 820 may be configured as or otherwise support a means for transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency.

By including or configuring the communications manager 820 in accordance with examples as described herein, the device 805 may support techniques for reduced power consumption and more efficient utilization of communication resources based on determining transmit powers for respective sidelink communications that are frequency domain multiplexed.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of sidelink power control for multiplexed transmissions as described herein, or the processor 840 and the memory 830 may be otherwise configured to perform or support such operations.

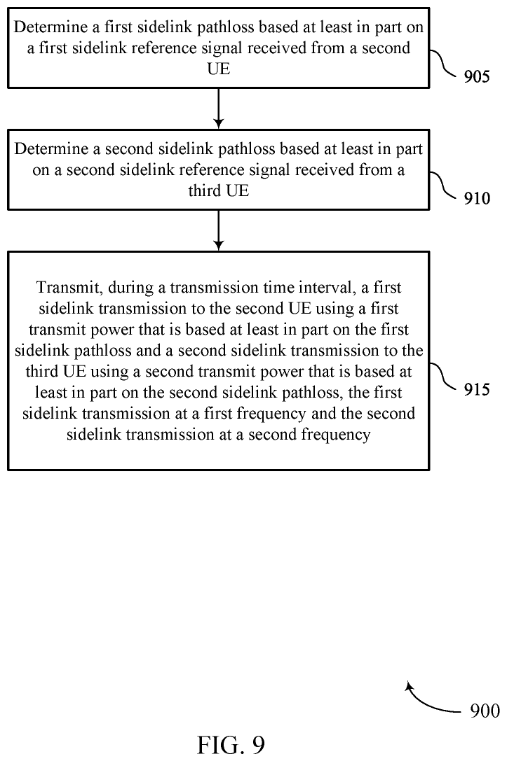

FIG. 9 shows a flowchart illustrating a method 900 that supports sidelink power control for multiplexed transmissions in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include determining a first sidelink pathloss based on a first sidelink reference signal received from a second UE. The operations of 905 may be performed in accordance with examples as disclosed herein. In some examples, aspects of the operations of 905 may be performed by a first sidelink pathloss component 725 as described with reference to FIG. 7. Additionally or alternatively, means for performing 905 may, but not necessarily, include, for example, antenna 825, transceiver 815, communications manager 820, memory 830 (including code 835), processor 840 and/or bus 845.

At 910, the method may include determining a second sidelink pathloss based on a second sidelink reference signal received from a third UE. The operations of 910 may be performed in accordance with examples as disclosed herein. In some examples, aspects of the operations of 910 may be performed by a second sidelink pathloss component 730 as described with reference to FIG. 7. Additionally or alternatively, means for performing 910 may, but not necessarily, include, for example, antenna 825, transceiver 815, communications manager 820, memory 830 (including code 835), processor 840 and/or bus 845.

At 915, the method may include transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency. The operations of 915 may be performed in accordance with examples as disclosed herein. In some examples, aspects of the operations of 915 may be performed by a communication interface 735 as described with reference to FIG. 7. Additionally or alternatively, means for performing 915 may, but not necessarily, include, for example, antenna 825, transceiver 815, communications manager 820, memory 830 (including code 835), processor 840 and/or bus 845.

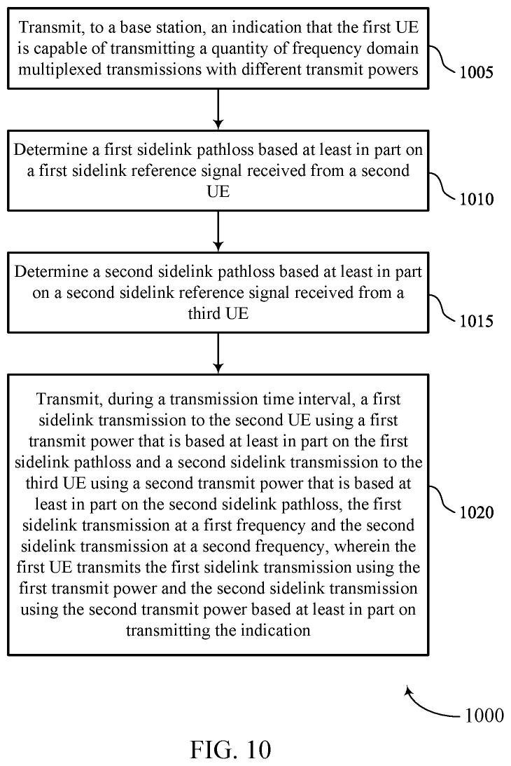

FIG. 10 shows a flowchart illustrating a method 1000 that supports sidelink power control for multiplexed transmissions in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include transmitting, to a base station, an indication that the first UE is capable of transmitting a quantity of frequency domain multiplexed transmissions with different transmit powers. The operations of 1005 may be performed in accordance with examples as disclosed herein. In some examples, aspects of the operations of 1005 may be performed by an FDM capability component 740 as described with reference to FIG. 7. Additionally or alternatively, means for performing 1005 may, but not necessarily, include, for example, antenna 825, transceiver 815, communications manager 820, memory 830 (including code 835), processor 840 and/or bus 845.

At 1010, the method may include determining a first sidelink pathloss based on a first sidelink reference signal received from a second UE. The operations of 1010 may be performed in accordance with examples as disclosed herein. In some examples, aspects of the operations of 1010 may be performed by a first sidelink pathloss component 725 as described with reference to FIG. 7. Additionally or alternatively, means for performing 1010 may, but not necessarily, include, for example, antenna 825, transceiver 815, communications manager 820, memory 830 (including code 835), processor 840 and/or bus 845.

At 1015, the method may include determining a second sidelink pathloss based on a second sidelink reference signal received from a third UE. The operations of 1015 may be performed in accordance with examples as disclosed herein. In some examples, aspects of the operations of 1015 may be performed by a second sidelink pathloss component 730 as described with reference to FIG. 7. Additionally or alternatively, means for performing 1015 may, but not necessarily, include, for example, antenna 825, transceiver 815, communications manager 820, memory 830 (including code 835), processor 840 and/or bus 845.

At 1020, the method may include transmitting, during a transmission time interval, a first sidelink transmission to the second UE using a first transmit power that is based on the first sidelink pathloss and a second sidelink transmission to the third UE using a second transmit power that is based on the second sidelink pathloss, the first sidelink transmission at a first frequency and the second sidelink transmission at a second frequency, where the first UE transmits the first sidelink transmission using the first transmit power and the second sidelink transmission using the second transmit power based on transmitting the indication. The operations of 1020 may be performed in accordance with examples as disclosed herein. In some examples, aspects of the operations of 1020 may be performed by a communication interface 735 as described with reference to FIG. 7. Additionally or alternatively, means for performing 1020 may, but not necessarily, include, for example, antenna 825, transceiver 815, communications manager 820, memory 830 (including code 835), processor 840 and/or bus 845.

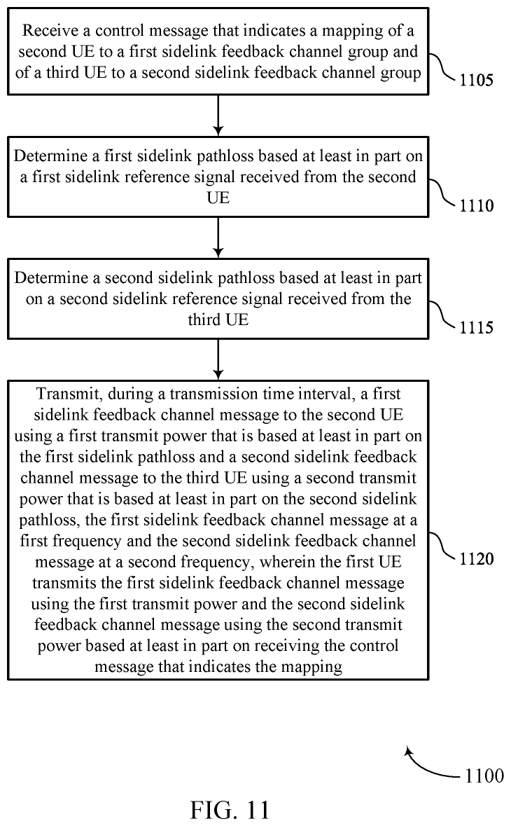

FIG. 11 shows a flowchart illustrating a method 1100 that supports sidelink power control for multiplexed transmissions in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include receiving a control message that indicates a mapping of a second UE to a first sidelink feedback channel group and of a third UE to a second sidelink feedback channel group. The operations of 1105 may be performed in accordance with examples as disclosed herein. In some examples, aspects of the operations of 1105 may be performed by a UE grouping component 745 as described with reference to FIG. 7. Additionally or alternatively, means for performing 1105 may, but not necessarily, include, for example, antenna 825, transceiver 815, communications manager 820, memory 830 (including code 835), processor 840 and/or bus 845.

At 1110, the method may include determining a first sidelink pathloss based on a first sidelink reference signal received from the second UE. The operations of 1110 may be performed in accordance with examples as disclosed herein. In some examples, aspects of the operations of 1110 may be performed by a first sidelink pathloss component 725 as described with reference to FIG. 7. Additionally or alternatively, means for performing 1110 may, but not necessarily, include, for example, antenna 825, transceiver 815, communications manager 820, memory 830 (including code 835), processor 840 and/or bus 845.

At 1115, the method may include determining a second sidelink pathloss based on a second sidelink reference signal received from the third UE. The operations of 1115 may be performed in accordance with examples as disclosed herein. In some examples, aspects of the operations of 1115 may be performed by a second sidelink pathloss component 730 as described with reference to FIG. 7. Additionally or alternatively, means for performing 1115 may, but not necessarily, include, for example, antenna 825, transceiver 815, communications manager 820, memory 830 (including code 835), processor 840 and/or bus 845.

At 1120, the method may include transmitting, during a transmission time interval, a first sidelink feedback channel message to the second UE using a first transmit power that is based on the first sidelink pathloss and a second sidelink feedback channel message to the third UE using a second transmit power that is based on the second sidelink pathloss, the first sidelink feedback channel message at a first frequency and the second sidelink feedback channel message at a second frequency, wherein the first UE transmits the first sidelink feedback channel message using the first transmit power and the second sidelink feedback channel message using the second transmit power based at least in part on receiving the control message that indicates the mapping. The operations of 1120 may be performed in accordance with examples as disclosed herein. In some examples, aspects of the operations of 1120 may be performed by a communication interface 735 as described with reference to FIG. 7. Additionally or alternatively, means for performing 1120 may, but not necessarily, include, for example, antenna 825, transceiver 815, communications manager 820, memory 830 (including code 835), processor 840 and/or bus 845.

The following provides an overview of aspects of the present disclosure:

Aspect 1: A method for wireless communications at a first UE, comprising: determining a first sidelink pathloss based at least in part on a first sidelink reference signal received from a second UE; determining a second sidelink pathloss based at least in part on a second sidelink reference signal received from a third UE; and transmitting, during a transmission time interval, a first sidelink transmission to the second UE using a first transmit power that is based at least in part on the first sidelink pathloss and a second sidelink transmission to the third UE using a second transmit power that is based at least in part on the second sidelink pathloss, the first sidelink transmission at a first frequency and the second sidelink transmission at a second frequency.

Aspect 2: The method of aspect 1, further comprising: transmitting, to a base station, an indication that the first UE is capable of transmitting a quantity of frequency domain multiplexed transmissions with different transmit powers, wherein the first UE transmits the first sidelink transmission using the first transmit power and the second sidelink transmission using the second transmit power based at least in part on transmitting the indication.

Aspect 3: The method of aspect 2, wherein the first UE is capable of transmitting frequency domain multiplexed transmissions with different transmit powers based at least in part on the first UE being configured with two or more radio frequency transmission chains.

Aspect 4: The method of any of aspects 2 through 3, wherein the first UE is capable of transmitting frequency domain multiplexed transmissions with different transmit powers using a single radio frequency transmission chain.

Aspect 5: The method of any of aspects 1 through 4, further comprising: receiving a control message that indicates a mapping of the second UE to a first sidelink feedback channel group and of the third UE to a second sidelink feedback channel group, wherein the first UE transmits a first sidelink feedback channel message as the first sidelink transmission using the first transmit power and a second sidelink feedback channel message as the second sidelink transmission using the second transmit power based at least in part on receiving the control message that indicates the mapping.

Aspect 6: The method of aspect 5, wherein receiving the control message comprises: receiving, from a base station, a radio resource control message, a medium access control layer control element message, or a downlink control information message that indicates the mapping.

Aspect 7: The method of any of aspects 5 through 6, wherein receiving the control message comprises: receiving, from the second UE, the third UE, or both, a sidelink radio resource control message, a sidelink medium access control layer control element message, or a sidelink control information message that indicates the mapping.

Aspect 8: The method of any of aspects 5 through 7, wherein receiving the control message comprises: receiving an indication that the first sidelink reference signal is to be used for determining the first sidelink pathloss and the second sidelink reference signal is to be used for determining the second sidelink pathloss.

Aspect 9: The method of any of aspects 1 through 8, further comprising: transmitting, to a fourth UE during the transmission time interval, a third sidelink feedback channel message using the first transmit power that is based at least in part on the first sidelink pathloss in accordance with the fourth UE being grouped with the second UE for sidelink feedback channel transmission.

Aspect 10: The method of aspect 9, wherein the fourth UE is grouped with the second UE based at least in part on a beam configuration used to communicate with the fourth UE and the second UE.

Aspect 11: The method of any of aspects 1 through 10, further comprising: determining a third sidelink pathloss based at least in part on a third sidelink reference signal received from a fourth UE; and transmitting, during the transmission time interval and using a radio frequency transmission chain that is used to transmit the first sidelink transmission, a third sidelink transmission to the fourth UE using a third transmit power that is based at least in part on the third sidelink pathloss.

Aspect 12: The method of any of aspects 1 through 11, further comprising: determining to use the first sidelink reference signal for determining the first sidelink pathloss based at least in part on a first beam used to communicate with the second UE; and determining to use the second sidelink reference signal for determining the second sidelink pathloss based at least in part on a second beam used to communicate with the third UE.

Aspect 13: The method of any of aspects 1 through 12, further comprising: receiving, based at least in part on the second UE and the third UE being configured within a same sidelink feedback channel group, a control message that indicates a first set of power control parameters to use to determine the first transmit power and a second set of power control parameters to use to determine the second transmit power.

Aspect 14: The method of any of aspects 1 through 13, wherein transmitting the first sidelink transmission and the second sidelink transmission comprises: transmitting a first sidelink feedback channel message using the first transmit power and a second sidelink feedback channel message using the second transmit power.

Aspect 15: The method of any of aspects 1 through 14, further comprising: adjusting a transmit power of a set of transmit powers corresponding to a set of sidelink feedback channel messages associated with a sidelink feedback channel group that includes the second UE and the third UE, the adjusting based at least in part on a transmit power constraint.

Aspect 16: The method of aspect 15, wherein adjusting the transmit power comprises: increasing or decreasing the transmit power based at least in part on a sidelink pathloss reference signal configuration at the first UE.

Aspect 17: The method of any of aspects 15 through 16, wherein adjusting the transmit power comprises: adjusting the transmit power within a range that is defined by a minimum transmit power of the set of transmit powers and a maximum transmit power of the set of transmit powers.

Aspect 18: The method of any of aspects 15 through 17, further comprising: adjusting the transmit power based at least in part on a minimum, maximum, or average of each transmit power of the set of transmit powers.

Aspect 19: The method of any of aspects 15 through 18, wherein adjusting the transmit power comprises: identifying a highest priority sidelink transmission associated with the sidelink feedback channel group; and adjusting the transmit power based at least in part on a second transmit power of the set of transmit powers, the second transmit power for a sidelink feedback channel message of the set of sidelink feedback channel messages that corresponds to the highest priority sidelink transmission.

Aspect 20: The method of any of aspects 15 through 19, further comprising: receiving, from a base station, an indication of a transmit power adjustment rule, wherein the transmit power is adjusted in accordance with the transmit power adjustment rule.

Aspect 21: The method of any of aspects 1 through 20, further comprising: determining a remaining transmit power based at least in part on the first transmit power, the second transmit power, and a transmit power constraint; and determining whether to transmit one or more additional sidelink transmissions based at least in part on the remaining transmit power.

Aspect 22: The method of aspect 21, wherein determining whether to transmit the one or more additional sidelink transmissions comprises: determining to not transmit the one or more additional sidelink transmissions based at least in part on the one or more additional sidelink transmissions being associated with a same priority and being associated with transmit powers that are greater than the remaining transmit power.

Aspect 23: The method of aspect 21, wherein determining whether to transmit the one or more additional sidelink transmissions comprises: determining to transmit at least one of the one or more additional sidelink transmissions that are associated with a same priority based at least in part on a resource block index, a subchannel index, a destination identifier, a priority of the destination identifier, or a combination thereof.

Aspect 24: The method of aspect 21, wherein determining whether to transmit the one or more additional sidelink transmissions comprises: determining to transmit at least one of the one or more additional sidelink transmissions that are associated with a same priority based at least in part on a lowest transmit power associated with the at least one of the one or more additional sidelink transmissions.

Aspect 25: The method of any of aspects 1 through 24, wherein transmitting the first sidelink transmission and the second sidelink transmission comprises: transmitting, during the transmission time interval, a first sidelink control channel transmission and a second sidelink control channel transmission, a first sidelink shared channel transmission and a second sidelink shared channel transmission, or a first sidelink reference signal transmission and a second sidelink reference signal transmission.

Aspect 26: The method of any of aspects 1 through 25, further comprising: determining the first transmit power, the second transmit power, or both, based at least in part on a closed-loop power control procedure.

Aspect 27: An apparatus comprising a processor; a transceiver coupled with the processor; and memory coupled with the processor, the memory and the processor configured to cause the apparatus to perform a method of any of aspects 1 through 26.

Aspect 28: An apparatus for wireless communications at a first UE, comprising at least one means for performing a method of any of aspects 1 through 26.

Aspect 29: A non-transitory computer-readable medium storing code for wireless communications at a first UE, the code comprising instructions executable by a processor to perform a method of any of aspects 1 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
determining a first sidelink pathloss based at least in part on a first sidelink reference signal received from a second UE;
determining a second sidelink pathloss based at least in part on a second sidelink reference signal received from a third UE; and
transmitting, during a transmission time interval, a first sidelink transmission to the second UE using a first transmit power that is based at least in part on the first sidelink pathloss and a second sidelink transmission to the third UE using a second transmit power that is based at least in part on the second sidelink pathloss, the first sidelink transmission at a first frequency and the second sidelink transmission at a second frequency.

2. The method of claim 1, further comprising:
transmitting, to a base station, an indication that the first UE is capable of transmitting a quantity of frequency domain multiplexed transmissions with different transmit powers, wherein the first UE transmits the first sidelink transmission using the first transmit power and the second sidelink transmission using the second transmit power based at least in part on transmitting the indication.

3. The method of claim 2, wherein the first UE is capable of transmitting frequency domain multiplexed transmissions with different transmit powers based at least in part on the first UE being configured with two or more radio frequency transmission chains or using a single radio frequency transmission chain.

4. The method of claim 1, further comprising:
receiving a control message that indicates a mapping of the second UE to a first sidelink feedback channel group and of the third UE to a second sidelink feedback channel group, wherein the first UE transmits a first sidelink feedback channel message as the first sidelink transmission using the first transmit power and a second sidelink feedback channel message as the second sidelink transmission using the second transmit power based at least in part on receiving the control message that indicates the mapping.

5. The method of claim 4, wherein receiving the control message comprises:
receiving, from a base station, a radio resource control message, a medium access control layer control element message, or a downlink control information message that indicates the mapping.

6. The method of claim 4, wherein receiving the control message comprises:
receiving, from the second UE, the third UE, or both, a sidelink radio resource control message, a sidelink medium access control layer control element message, or a sidelink control information message that indicates the mapping.

7. The method of claim 4, wherein receiving the control message comprises:
receiving an indication that the first sidelink reference signal is to be used for determining the first sidelink pathloss and the second sidelink reference signal is to be used for determining the second sidelink pathloss.

8. The method of claim 1, further comprising:
transmitting, to a fourth UE during the transmission time interval, a third sidelink feedback channel message using the first transmit power that is based at least in part on the first sidelink pathloss in accordance with the fourth UE being grouped with the second UE for sidelink feedback channel transmission, wherein the fourth UE is grouped with the second UE based at least in part on a beam configuration used to communicate with the fourth UE and the second UE.

9. The method of claim 1, further comprising:
determining a third sidelink pathloss based at least in part on a third sidelink reference signal received from a fourth UE; and
transmitting, during the transmission time interval and using a radio frequency transmission chain that is used to transmit the first sidelink transmission, a third sidelink transmission to the fourth UE using a third transmit power that is based at least in part on the third sidelink pathloss.

10. The method of claim 1, further comprising:
determining to use the first sidelink reference signal for determining the first sidelink pathloss based at least in part on a first beam used to communicate with the second UE; and
determining to use the second sidelink reference signal for determining the second sidelink pathloss based at least in part on a second beam used to communicate with the third UE.

11. The method of claim 1, further comprising:
receiving, based at least in part on the second UE and the third UE being configured within a same sidelink feedback channel group, a control message that indicates a first set of power control parameters to use to determine the first transmit power and a second set of power control parameters to use to determine the second transmit power.

12. The method of claim 1, wherein transmitting the first sidelink transmission and the second sidelink transmission comprises:
transmitting a first sidelink feedback channel message using the first transmit power and a second sidelink feedback channel message using the second transmit power.

13. The method of claim 1, further comprising:
adjusting a transmit power of a set of transmit powers corresponding to a set of sidelink feedback channel messages associated with a sidelink feedback channel group that includes the second UE and the third UE, the adjusting based at least in part on a transmit power constraint.

14. The method of claim 13, wherein adjusting the transmit power comprises:
increasing or decreasing the transmit power based at least in part on a sidelink pathloss reference signal configuration at the first UE, adjusting the transmit power within a range that is defined by a minimum transmit power of the set of transmit powers and a maximum transmit power of the set of transmit powers, or any combination thereof.

15. The method of claim 13, further comprising:
adjusting the transmit power based at least in part on a minimum, maximum, or average of each transmit power of the set of transmit powers.

16. The method of claim 13, wherein adjusting the transmit power comprises:
identifying a highest priority sidelink transmission associated with the sidelink feedback channel group; and
adjusting the transmit power based at least in part on a second transmit power of the set of transmit powers, the second transmit power for a sidelink feedback channel message of the set of sidelink feedback channel messages that corresponds to the highest priority sidelink transmission.

17. The method of claim 13, further comprising:
receiving, from a base station, an indication of a transmit power adjustment rule, wherein the transmit power is adjusted in accordance with the transmit power adjustment rule.

18. The method of claim 1, further comprising:
determining a remaining transmit power based at least in part on the first transmit power, the second transmit power, and a transmit power constraint; and
determining whether to transmit one or more additional sidelink transmissions based at least in part on the remaining transmit power.

19. The method of claim 18, wherein determining whether to transmit the one or more additional sidelink transmissions comprises:
determining to not transmit the one or more additional sidelink transmissions based at least in part on the one or more additional sidelink transmissions being associated with a same priority and being associated with transmit powers that are greater than the remaining transmit power.

20. The method of claim 18, wherein determining whether to transmit the one or more additional sidelink transmissions comprises:
determining to transmit at least one of the one or more additional sidelink transmissions that are associated with a same priority based at least in part on a resource block index, a subchannel index, a destination identifier, a priority of the destination identifier, or a combination thereof.

21. The method of claim 18, wherein determining whether to transmit the one or more additional sidelink transmissions comprises:
determining to transmit at least one of the one or more additional sidelink transmissions that are associated with a same priority based at least in part on a lowest transmit power associated with the at least one of the one or more additional sidelink transmissions.

22. The method of claim 1, wherein transmitting the first sidelink transmission and the second sidelink transmission comprises:
transmitting, during the transmission time interval, a first sidelink control channel transmission and a second sidelink control channel transmission, a first sidelink shared channel transmission and a second sidelink shared channel transmission, or a first sidelink reference signal transmission and a second sidelink reference signal transmission.

23. The method of claim 1, further comprising:
determining the first transmit power, the second transmit power, or both, based at least in part on a closed-loop power control procedure.

24. An apparatus for wireless communications, comprising:
a processor of a first user equipment (UE),
a transceiver coupled with the processor; and
memory coupled with the processor, the memory and processor configured to cause the apparatus to:
determine a first sidelink pathloss based at least in part on a first sidelink reference signal received from a second UE;
determine a second sidelink pathloss based at least in part on a second sidelink reference signal received from a third UE; and
transmit, via the transceiver, during a transmission time interval, a first sidelink transmission to the second UE using a first transmit power that is based at least in part on the first sidelink pathloss and a second sidelink transmission to the third UE using a second transmit power that is based at least in part on the second sidelink pathloss, the first sidelink transmission at a first frequency and the second sidelink transmission at a second frequency.

25. The apparatus of claim 24, the memory and the processor further configured to cause the apparatus to:
transmit, to a base station via the transceiver, an indication that the first UE is capable of transmitting a quantity of frequency domain multiplexed transmissions with different transmit powers, wherein the first UE transmits the first sidelink transmission using the first transmit power and the second sidelink transmission using the second transmit power based at least in part on transmitting the indication.

26. The apparatus of claim 24, the memory and the processor further configured to cause the apparatus to:
receive, via the transceiver, a control message that indicates a mapping of the second UE to a first sidelink feedback channel group and of the third UE to a second sidelink feedback channel group, wherein the first UE transmits a first sidelink feedback channel message as the first sidelink transmission using the first transmit power and a second sidelink feedback channel message as the second sidelink transmission using the second transmit power based at least in part on receiving the control message that indicates the mapping.

27. The apparatus of claim 24, the memory and the processor further configured to cause the apparatus to:
transmit, to a fourth UE during the transmission time interval via the transceiver, a third sidelink feedback channel message using the first transmit power that is based at least in part on the first sidelink pathloss in accordance with the fourth UE being grouped with the second UE for sidelink feedback channel transmission.

28. The apparatus of claim 24, the memory and the processor further configured to cause the apparatus to:
determine a third sidelink pathloss based at least in part on a third sidelink reference signal received from a fourth UE; and
transmit, during the transmission time interval via the transceiver and using a radio frequency transmission chain that is used to transmit the first sidelink transmission, a third sidelink transmission to the fourth UE using a third transmit power that is based at least in part on the third sidelink pathloss.

29. An apparatus for wireless communications at a first user equipment (UE), comprising:
means for determining a first sidelink pathloss based at least in part on a first sidelink reference signal received from a second UE;
means for determining a second sidelink pathloss based at least in part on a second sidelink reference signal received from a third UE; and
means for transmitting, during a transmission time interval, a first sidelink transmission to the second UE using a first transmit power that is based at least in part on the first sidelink pathloss and a second sidelink transmission to the third UE using a second transmit power that is based at least in part on the second sidelink pathloss, the first sidelink transmission at a first frequency and the second sidelink transmission at a second frequency.

30. A non-transitory computer-readable medium storing code for wireless communications at a first user equipment (UE), the code comprising instructions executable by a processor to:
determine a first sidelink pathloss based at least in part on a first sidelink reference signal received from a second UE;
determine a second sidelink pathloss based at least in part on a second sidelink reference signal received from a third UE; and
transmit, during a transmission time interval, a first sidelink transmission to the second UE using a first transmit power that is based at least in part on the first sidelink pathloss and a second sidelink transmission to the third UE using a second transmit power that is based at least in part on the second sidelink pathloss, the first sidelink transmission at a first frequency and the second sidelink transmission at a second frequency.
